(19) United States
(12) Patent Application Publication
(10) Pub. No.: US 2025/0330904 A1
(43) Pub. Date: Oct. 23, 2025

(54) FACILITATING GENERALIZED CELL RESELECTION FOR NETWORK ENERGY SAVINGS USING GRAPH-BASED ABSTRACTIONS IN ADVANCED COMMUNICATION NETWORKS

(71) Applicant: Dell Products L.P., Round Rock, TX (US)

(72) Inventors: Jeebak Mitra, Ottawa (CA); Javad Mirzaei, Toronto (CA)

(21) Appl. No.: 18/638,408

(22) Filed: Apr. 17, 2024

(51) Int. Cl. H04W 52/02; H04W 24/02; H04W 28/08

(52) U.S. Cl. CPC H04W 52/0206; H04W 24/02; H04W 28/0892

(57) ABSTRACT

Facilitating generalized cell reselection for network energy savings using graph-based abstractions in advanced communication networks is provided. A method includes determining, by a system comprising at least one processor, respective results of application of an objective formulation to respective combinations of a specified user equipment of a source cell and respective target cells of a group of target cells. A communication network comprises the source cell and the group of target cells. The method also includes, based on the respective results of the application of the objective formulation, facilitating, by the system, user equipment association that defines an action for a network traffic load balancing process that transfers network traffic of the specified user equipment from the source cell to a target cell of the group of target cells.

### BACKGROUND

The use of computing devices is ubiquitous. Given the explosive demand placed upon mobility networks and the advent of advanced use cases (e.g., streaming, gaming, and so on), power consumption in such networks is higher as compared to Long Term Evolution (LTE) networks, for example. Such power consumption can be attributed to the exponential increase in the network data flowing through the advanced network and the need for faster processing of complex tasks to enable the high data rates. Accordingly, unique challenges exist related to network efficiency and in view of forthcoming Fifth Generation (5G), new radio (NR), Sixth Generation (6G), or other next generation, standards for network communication.

The above-described context with respect to communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes determining, by a system comprising at least one processor, respective results of application of an objective formulation to respective combinations of a specified user equipment of a source cell and respective target cells of a group of target cells. A communication network comprises the source cell and the group of target cells. The method also includes, based on the respective results of the application of the objective formulation, facilitating, by the system, user equipment association that defines an action for a network traffic load balancing process that transfers network traffic of the specified user equipment from the source cell to a target cell of the group of target cells. In an implementation, the source cell and the group of target cells can be configured to operate according to a fifth generation radio network communication protocol, a 5G radio network communication protocol, advanced radio network communication protocols, beyond 5G radio network communication protocols, and/or other radio network communication protocols.

According to some implementations, determining of the respective results of application of the objective formulation can include, based on the user equipment association, determining a first result of a minimization formulation that minimizes an average energy consumption of the communication network, as compared to a currently measured average energy consumption. Further, determining of the respective results of application of the objective formulation can also include determining a second result of a maximization formulation that maximizes a carried traffic metric of the communication network, as compared to a currently measured carried traffic metric during the facilitating the user equipment association.

Further to the above implementations, determining of the first result can include applying a constraint to the minimization formulation. The constraint facilitates maintaining cells, determined to be necessary for network guaranteed bit rate traffic, in an active state. In addition, applying of the constraint can include maintaining a defined guaranteed bit rate level for instantaneous minimization formulation bit rate traffic.

In some implementations, the method can include, prior to determining of the respective results of the application of the objective formulation, transforming, by the system, details of the communication network into a graphical representation. The method can also include, based on the graphical representation and based on real-time conditions (as an input), generating, by the system, a policy (the potential set of actions, for example, migration of UE can be deterministic) that is not known a priori. The policy facilitates a reduction in an amount of energy consumed by the communication network, as compared to a current energy consumption level.

Further to the above implementations, prior to generating of the policy and based on the graphical representation, the method can include training, by the system, a model to a defined confidence level. The model can be a graph neural network model. For example, the graph neural network model can be a message passing graph neural network model. However, the disclosed embodiments are not limited to a message passing graph neural network model.

The method can include, according to some implementations, prior to the determining of the respective results of application of the objective formulation and based on a traffic class of the specified user equipment, applying, by the system, a weighted value in the objective formulation for the specified user equipment. The weighted value can define a prioritization assigned to the specified user equipment. Further to these implementations, a weighted combination of quality of service parameters can serve as a constraint within the objective formulation.

Another embodiment relates to a system that includes a processor and a memory that stores executable instructions that, when executed by the processor, facilitate performance of operations. The operations can include performing a network traffic load balancing procedure that moves network traffic of a user equipment from a source cell to a specified target cell within a communication network. Performing the network traffic load balancing procedure can include determining respective results of application of an objective formulation to respective combinations of the user equipment and respective target cells of a group of target cells of the communication network. Further, performing the network traffic load balancing procedure can include, based on the respective results and a determination that the specified target cell satisfies an energy consumption condition, transferring the network traffic of the user equipment from the source cell to the specified target cell.

In some implementations, the operations can include, prior to the determining of the respective results of the application of the objective formulation, training a first model to a defined confidence level. The first model can be a graph neural network model.

The objective formulation can facilitate a tradeoff between user equipment quality of service and an energy consumption of the communication network, in some implementations. The user equipment quality of service can be defined for respective user equipment classes of user equipment within the communication network.

In accordance with some implementations, the operations can include determining network guaranteed bit rate traffic is dependent on the source cell being in an active state. The operations can also include preventing a change in state of the source cell from the active state to an inactive state, wherein the preventing comprises applying a constraint to the objective formulation.

Yet another embodiment relates to a non-transitory machine-readable medium, comprising executable instructions that, when executed by a processor of network equipment, facilitate performance of operations. The operations can include determining respective results of application of an objective formulation to respective combinations of a user equipment connected to a communication network via a source cell and respective target cells of a group of target cells. The communication network comprises the source cell and the group of target cells. The operations can also include, based on the respective results of the application of the objective formulation, implementing a network traffic load balancing process that transfers the user equipment from being connected to the source cell to being connected to a target cell selected from the group of target cells.

In some implementations, the operations can include, based on a graphical representation of the communication network, using a model trained to a defined level of confidence, wherein the model is a graph neural network model. According to some implementations, the objective formulation is based on an optimization function that facilitates a tradeoff between network energy savings and maintaining a user equipment quality of service at a defined level. Further the user equipment quality of service is defined for respective user equipment classes of user equipment within the communication network.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, cellular wireless network in accordance with one or more embodiments described herein;

FIGS. 2A and 2B illustrate the example, non-limiting, cellular wireless network of FIG. 1 where network energy savings inspired load balancing has been applied in the network cluster in accordance with one or more embodiments described herein;

FIG. 3 illustrates an example, non-limiting, schematic representation of graph embedding in accordance with one or more embodiments described herein;

FIG. 4 illustrates a logical connectivity graph representation between cell sites and user equipment in accordance with one or more embodiments described herein;

FIG. 5 illustrates an example, non-limiting, graph neural network based representation of a network in accordance with one or more embodiments described herein;

FIG. 6 illustrates an example, non-limiting, representation of a graph neural network training process using a loss function in accordance with one or more embodiments described herein;

FIG. 7 illustrates an example, non-limiting, schematic representation of the deployment of the trained graph neural network for network energy savings in accordance with one or more embodiments described herein;

FIG. 8 illustrates an example, non-limiting, pooled power model for a heterogenous network architecture in accordance with one or more embodiments described herein;

FIG. 9 illustrates an example, non-limiting, entire process of transforming from a given network topology, to its graphical representation, to using such graph rendering to arrive at an optimal user association policy that prioritizes network energy savings in accordance with one or more embodiments described herein;

FIG. 10 illustrates an example, non-limiting, flow diagram of a computer-implemented method that facilitates cell reselection in accordance with one or more embodiments described herein;

FIG. 11 illustrates an example, non-limiting, computing environment in which one or more embodiments described herein can be facilitated;

FIG. 12 illustrates an example, non-limiting, networking environment in which one or more embodiments described herein can be facilitated;

FIG. 13 illustrates an example, non-limiting, first equation that mathematically represents the problem being addressed herein in accordance with one or more embodiments described herein;

FIG. 14 illustrates a second equation that mathematically expresses the total power consumption of the network in accordance with one or more embodiments described herein;

FIG. 15A illustrates a third equation that provides a set of constraints in accordance with one or more embodiments described herein;

FIG. 15B illustrates a first term in the third equation that represents the peak average power consumption limit in accordance with one or more embodiments described herein;

FIG. 15C illustrates a second term in the third equation that represents instantaneous power consumption in accordance with one or more embodiments described herein;

FIG. 15D illustrates a third term in the third equation that represents the change in power consumption when carrying a load in accordance with one or more embodiments described herein;

FIG. 16 illustrates a fourth equation in accordance with one or more embodiments described herein;

FIG. 17A illustrates a fifth equation in accordance with one or more embodiments described herein;

FIG. 17B illustrates a sixth equation, which is related to the fifth equation, in accordance with one or more embodiments described herein;

FIG. 17C illustrates a seventh equation derived from the fifth equation in accordance with one or more embodiments described herein;

FIG. 18A illustrates an eighth equation for minimizing the average network energy consumption in accordance with one or more embodiments described herein;

FIG. 18B illustrates a ninth equation derived in view of a goal to have a highest carried traffic possible in accordance with one or more embodiments described herein;

FIG. 19A illustrates a tenth equation of a constraint utilized so that energy consumption minimization does not recommend switching off base stations that are critical for network guaranteed bit rate traffic in accordance with one or more embodiments described herein;

FIG. 19B illustrates an eleventh equation for a constraint of FIG. 19A in accordance with one or more embodiments described herein;

FIG. 20A illustrates a twelfth equation for a new power metric for the base stations in accordance with one or more embodiments described herein;

FIG. 20B illustrates a first element of the twelfth equation in accordance with one or more embodiments described herein;

FIG. 20C illustrates a thirteenth equation according to a network energy savings policy recommendation in accordance with one or more embodiments described herein;

FIG. 20D illustrates a second element of the twelfth equation in accordance with one or more embodiments described herein;

FIG. 21A illustrates a fourteenth equation that represents a wireless network as a graph in accordance with one or more embodiments described herein;

FIG. 21B illustrates a fifteenth equation that denotes the set of nodes representing the user equipment and radio units in the network in accordance with one or more embodiments described herein;

FIG. 21C illustrates a sixteenth equation that denotes edges representing the link between the nodes in accordance with one or more embodiments described herein;

FIG. 21D illustrates a seventeenth equation that defines an adjacency matrix of the graph in accordance with one or more embodiments described herein;

FIG. 21E illustrates an eighteenth equation that denotes a reference signal received power measurement between a first node and a second node in accordance with one or more embodiments described herein;

FIG. 22A illustrates a nineteenth equation for defining the loss function in accordance with one or more embodiments described herein; and

FIG. 22B illustrates a twentieth equation for updating the set of parameters that is used to characterize the graph neural network in accordance with one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

In conventional cellular networks, Base Stations (BSs) are the major energy consumers and can account for about 60% to 80% of the total power consumption in a cellular network. With the development of energy efficient radios, different types of energy saving features have been proposed which include use of higher-efficiency power amplifiers that can help in reducing the transmit power while meeting the targeted Quality of Service (QOS), through improved scheduling methods, for example. However, most conventional networks follow the strategy of maintaining the BS in a fully operational state even when traffic loads are low within the coverage area of the BS, leading to significant energy wastage.

From an energy efficiency perspective, load adaptive network operation should potentially be executed as traffic loads of cellular networks show both temporal and spatial variation. For example, one approach could ensure that the BSs are either completely switched off and/or operate in low power consumption modes during periods of negligible traffic to optimize the energy efficiency. It may, however, not always be feasible to completely switch off BSs in the network due to several reasons such as, for example, potentially bursty traffic or the possibility of coverage holes that would render a portion of the user equipment (UE) without any connectivity to the network. This can jeopardize metrics, such as UE QoS that mobile network operators (MNOs) are concerned with in order to retain and increase user subscriptions. Moreover, a BS in a state of hibernation may not be able to transmit signals (such as broadcast information including synchronization signals) needed by the UEs to establish connections.

Cell switching can be effective in terms of Network Energy Savings (NES). According to cell switching, a cell with low load traffic is geared towards switching off completely and therefore the UEs that are associated with that cell need to find another BS to connect to in order to maintain their connectivity to the network. While analytical models have been developed over the years to determine the best cell to switch to (from a group of active candidate cells), such analytical models are inefficient at taking into account historical data and states of the network and become quite complex when trying to incorporate such historical data. On the other hand, data-driven solutions leveraging machine learning (ML) have an innate capability of being able to account for various attributes through its training process and then further using online learning methods to continue to receive feedback on a quasi-real time basis. Given the number of parameters to consider and the overall complexity associated with UE migration, formulating the problem in a way such that ML approaches may be applied with the right kind of training is a non-trivial exercise. Furthermore, the solution needs to ensure applicability to topological changes, QoS satisfaction and meet mobile network operator (MNO) driven energy savings targets simultaneously, adding further layers of complexity.

In cellular networks, the most common metric used for UE association or the selection of a base station (BS) for a UE to connect to is Received Signal Strength Indicator (RSSI) or, when connected, the reference signal received power (RSRP) whereby, the reference signal is a signal whose transmit power level is known to the UE. The UE tends to associate itself with the BS, with the highest RSSI and/or RSRP. While straightforward, it can be easily determined that this approach can end up being sub-optimal from a global network utilization perspective, as there is a possibility of creating traffic hotspots within the network while other adjacent BSs are not used as much. In fact, despite the highest RSSI, the UE throughput may suffer if the BS is unable to allocate adequate resources to the UE. Equally important for next generation network design is the energy consumption which may not be optimal when certain BSs are overloaded (and therefore forced to use higher energy consuming high throughput transmission configurations) while others are available, yet lightly used. In order to improve network energy savings (NES), often cells that are underutilized can be switched to a lower power consumption mode where they only serve a small number of UEs or are completely switched off if the UEs anchored on the lightly used cells can be re-associated with other active cells. UEs may also be re-associated with other BSs to balance the energy consumption of BSs and allow high traffic BSs to shift to lower power consuming modes opportunistically.

Network energy consumption increases in proportion to the throughput requirements and the various enabling techniques, such as wider bandwidth and greater spatial dimensions, that are put in place to enable these throughputs. While energy consumptions of cellular networks have been steadily increasing for the past decade, the issue is considered to be particularly prohibitive for 5G and beyond 5G networks (e.g., advanced networks) due to increased density of deployment and the support for multiple antennas, which can range from a few to hundreds of antennas. The various use cases on which the development and deployment of 5G technology is funded often do not need a constant stream of high data rate and, even then, may only need a constant stream of high data rate during certain times of the day. Therefore, a network that is adaptive to varying demands in terms of resource utilization is critically needed and provided with the disclosed embodiments.

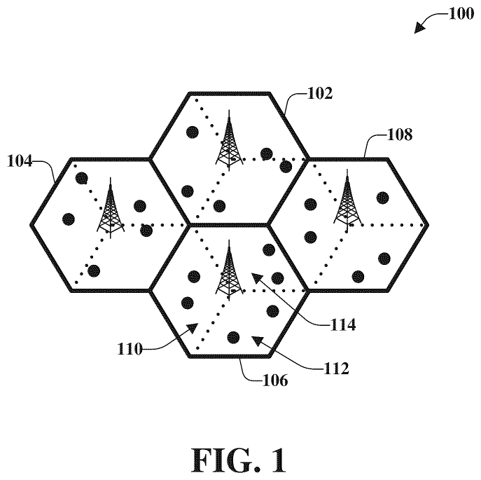

FIG. 1 illustrates an example, non-limiting, cellular wireless network 100 in accordance with one or more embodiments. As illustrated, the cellular wireless network 100 can include randomly distributed UEs and the cellular wireless network 100 can include tri-sector antenna. Network energy consumption can be saved by operating certain BSs within a network cluster (e.g., the cellular wireless network 100) in low capacity modes when network traffic is low or if the conditions permit switching the BSs off completely. In such an event the UEs associated with these BSs will need to find an alternative BS to connect to in order to meet their traffic requirements.

For illustration purposes, as illustrated in FIG. 1, the cellular wireless network 100 includes a cellular network cluster with 4 cell sites, labeled as a first cell site 102, a second cell site 104, a third cell site 106, and a fourth cell site 108. Each cell site houses a 120 degree coverage isotropic antenna such that each cell-site is a tri-sector with BSs catering to the UEs (depicted as the filled circles) in their own 120 degree zone within a hexagonal cell. The tri-sectors are demarcated in each cell site by the dashed lines. For example, the tri-sectors of the third cell site 106 are labeled as a first tri-sector 110, a second tri-sector 112, and a third tri-sector 114. The tri-sectors of the other cell sites are not labeled for purposes of simplicity. The users within the interior or each cell connect to the RU that has the highest RSRP (e.g., closest in a radio frequency (RF) signal strength sense), while for those closer to the cell edge, factors beyond RSRP might not be considered. A challenge associated with conventional systems is the lack of data driven approaches to NES based load balancing. For example, NES as an objective by using methods such as cell reselection have been considered only very recently and therefore strategies that minimize energy consumption in a network wide manner while meeting traffic demands in a non-disruptive way are currently under investigation. Due to the complexity of the interactions and dependencies, analytical modeling is either hard or deficient in terms of capturing the entire dynamic. Data-driven approaches that can be implemented with relatively low complexity are very much needed. Another challenge associated with conventional systems is the assumption of heterogenous networks (HetNet) with an in-built coverage layer. In such conventional systems, energy efficiency optimization by switching off certain base stations has primarily been considered when there is existence of an overlay network using Macro base stations (MBS) that are responsible for providing coverage and connectivity to UEs within its coverage area. Simultaneously, there are hotspots where demand for throughput is determined to be higher through various offline capacity planning exercises that are serviced by small cell base stations (SBS) within the coverage area of the MBS. A determination of which cell can be switched off then is only restricted to these SBSs being switched off when significant data demand does not exist and the residual demand that may occur if an SBS is switched off can potentially be serviced by the MBS, making it a relatively simpler problem. Yet another challenge associated with conventional systems is the problem formulation for cell reselection with joint objective of NES and QoS satisfaction. Wireless networks over the course of operation often end up having a fairly non-uniform distribution of traffic whereby certain BSs carry a higher traffic load compared to others due to the varying distribution of the users and their respective demands. While a large amount of analysis goes into wireless network planning prior to deploying BSs to determine the intersite distance (ISD) and the BS capabilities, and so on, there are several factors that may lead to the traffic distribution changing during the day or over extended periods such that the initial deployment ends up being sub-optimal and load balancing based on traffic demand and BS load needs to be performed to improve fairness index. While, doing this from a throughput maximization and/or user QoS satisfaction has received a fair bit of interest, load balancing for equitable energy consumption across BSs while minimizing a global energy consumption metric has not been considered as much. Still another challenge associated with conventional systems is the lack of scalable AI/ML based (Artificial Intelligence (AI) and/or Machine Learning (ML)) approaches. Many wireless devices are constrained by their limited computing capacity, and thus, are unable to train high-complexity ML models. Furthermore, in environments where distributed processing is inherent, training and initialization of ML models poses a significant challenge as the computing platform may not be able to localize the training of the models without increasing complexity significantly. Moreover, some of the architectures used conventionally for ML, such as multi-layer perceptron (MLP), convolutional neural networks (CNNs) are borrowed from the fields of image processing, computer vision and the like, which do not have a lot of similarity with the time evolution of wireless network behavior. Unfortunately, these architectures are able to address either only localized issues or apply to small-scale wireless networks. There is, therefore, a need for methods that inherently exploit the wireless network topologies and can scale and be generalizable in large cellular network resource management aspects.

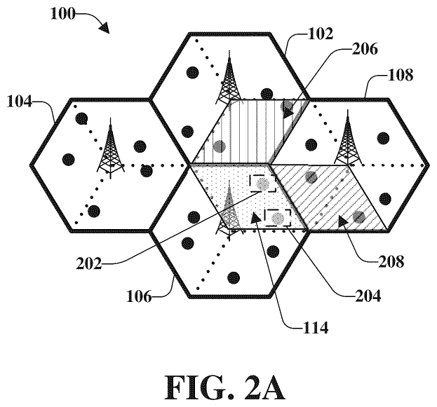

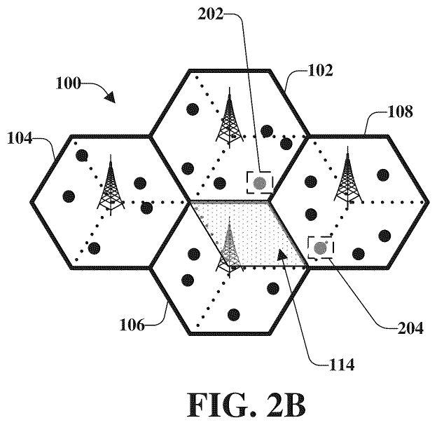

FIGS. 2A and 2B illustrate the example, non-limiting, cellular wireless network 100 of FIG. 1 where NES inspired load balancing has been applied in the network cluster in accordance with one or more embodiments. Repetitive description of like elements employed in other embodiments described herein is omitted for sake of brevity.

The problem of UEs association for NES is depicted in FIGS. 2A and 2B. In FIG. 2A, a cell site with low traffic is identified and, in this example, is the third tri-sector 114 of the third cell site 106. Further, two representative UEs (identified within the dotted squares and labeled as a first defined or specified UE (first UE 202) and a second defined or specified UE (second UE 204)) that are connected to the BS under test (in the third cell site 106) need to be offloaded to neighbor cells prior to this cell (e.g., the third cell site 106) being switched off. Since the overall traffic demand in this cell (e.g., the third cell site 106) is deemed low, the third cell site 106 can potentially be turned off completely based on an accurate enough traffic prediction regarding the activity of the third cell site 106.

Consequently, neighboring cell sites (illustrated as area 206 of the first cell site 102 and area 208 of the fourth cell site 108) are identified as potential BSs to which the affected UEs (the first UE 202 and the second UE 204) can migrate. The determination of this can become more complex when (a) there are several candidate cells in the neighborhood for the UEs to migrate to and (b) there are several UEs to migrate. In the latter case, the overhead for UE migration may also be a factor to consider from a cost perspective, other than the impact on UE QoS. A policy change is made only when the potential benefits (energy savings) outweigh the costs (e.g., QoS impact, handover costs).

Continuing the above example, FIG. 2B illustrates the result of migration of the candidate users (e.g., the first UE 202, the second UE 204) for Energy Consumption (EC) reduction. As illustrated, the UEs are reassociated with other cell sites. For example, the first UE 202 has been migrated to the first cell site 102 and the second UE 204 has been migrated to the fourth cell site 108. Since the third tri-sector 114 now has no connectivity with any UEs, the cell site (e.g., the third tri-sector 114) can be switched off.

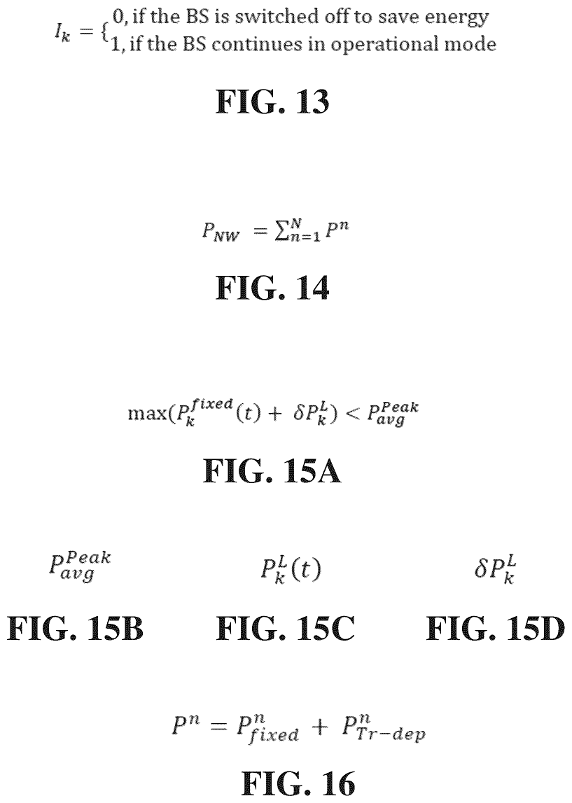

The problem being addressed herein can be mathematically expressed as indicated in the following first equation (Eqn. (1)), also illustrated in FIG. 13, in accordance with one or more embodiments:

$${I}_{k} = \{ \begin{matrix}0 , if the BS is switched off to save energy \\ 1 , if the BS continues in operational mode\end{matrix} \qquad Eqn . ( 1 )$$

As indicated in the Eqn (1), an indicator variable is used for the status of the various BSs. The objective of the Eqn (1) is to associate each user (UE) with a BS that minimizes the overall energy consumption of the network, while maximizing the traffic carried out by the network. It is noted that in a homogenous network, the Eqn (1) implies that any Macro BS can be switched off at any time as per the traffic load conditions and the network policy. In all cases, the minimization of energy consumption takes precedence subject to minimum traffic that is attributed to the guaranteed bit rate (GBR) demand so as to make sure QoS metrics for the most traffic classes with the most stringent requirements do not suffer due to the EC minimization objective.

The total power consumption of the network is mathematically expressed as indicated in the following second equation (Eqn. (2)), also illustrated in FIG. 14, in accordance with one or more embodiments:

$${P}_{NW} = {\sum }_{n = 1}^{N} {P}^{n} . \qquad Eqn . ( 2 )$$

As provided herein, the overall objective is to minimize the total energy consumption of the network or, in other words, maximize the energy efficiency (EE) of the network (e.g., an optimization objective). Additionally, an objective is to make sure that network traffic is well supported and maximized within the EC constraint, as mathematically expressed by the Eqn. (2).

A third equation (Eqn. (3)), indicated below (also illustrated in FIG. 15A) provides a set of constraints in accordance with one or more embodiments.

$$max ( {P}_{k}^{fixed} ( t ) + δ {P}_{k}^{L} ) < {P}_{avg}^{Peak} . \qquad Eqn . ( 3 )$$

Term1 of Eqn. (3),

$${P}_{avg}^{Peak} ,$$

represents the peak average power consumption limit (also illustrated in FIG. 15B) in accordance with one or more embodiments. In accordance with the constraints of Eqn. (3), the maximum power consumption of any BS in the network may not exceed the peak average power consumption limit

$${P}_{avg}^{Peak} .$$

Each BS has a fixed portion of power consumption and a traffic load dependent portion. Term2 of Eqn. (3),

$${P}_{k}^{L} ( t ) ,$$

represents instantaneous power consumption (also illustrated in FIG. 15C) in accordance with one or more embodiments. More specifically, Term2 of Eqn. (3),

$${P}_{k}^{L} ( t ) ,$$

represents the instantaneous power consumption of the k^{th} BS that is attributable to the fixed power dissipation that occurs regardless of the traffic load. Term3 of Eqn. (3),

$$δ {P}_{k}^{L} ,$$

represents the change in power consumption when carrying a load L (also illustrated in FIG. 15D) in accordance with one or more embodiments.

The various aspects discussed herein do not affect the fixed power consumption since the fixed power consumption is a function of the equipment design. Scheduling enhancements for NES can be applied to each of the macro BS and the overall formulation of energy consumption minimization is transparent to the network cluster behavior. Since the power consumption is traffic dependent as mentioned above, it is given by the fourth equation (Eqn. (4)) indicated below (also illustrated in FIG. 16) in accordance with one or more embodiments.

$${P}^{n} = {P}_{fixed}^{n} + {P}_{Tr - dep}^{n} . \qquad Eqn . ( 4 )$$

Term1 of Eqn. (4), P_{fixed}, represents the fixed power consumption of the BS when carrying no traffic in accordance with one or more embodiments. It is noted the embodiments provided herein do not help to minimize the fixed power consumption of the BS (P_{fixed}) unless the BS is switched off completely and all UEs connected to that BS (if any) are migrated to a different cell.

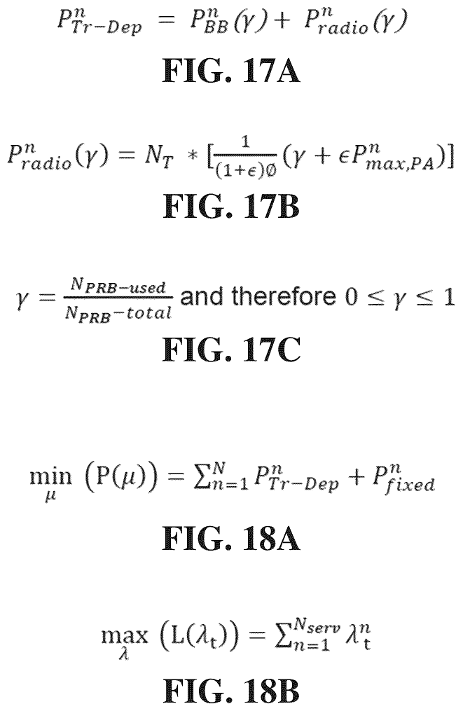

Depicted below is a fifth equation (Eqn. (5)), also illustrated in FIG. 17A, in accordance with one or more embodiments:

$${P}_{Tr - Dep}^{n} = {P}_{BB}^{n} ( γ ) + {P}_{radio}^{n} ( γ ) . \qquad Eqn . ( 5 )$$

where a sixth equation (Eqn. (6)), depicted below (also illustrated in FIG. 17B), applies:

$${P}_{radio}^{n} ( γ ) = {N}_{T} * [ \frac{\text{?}}{( 1 + ϵ ) \text{?}} ( γ + ϵ \text{?} ) ] . \qquad Eqn . ( 6 )$$

$$\text{?} \text{indicates text missing or illegible when filed}$$

where N_{T}, represents the number of active transmit antennas, θ represents a maximum efficiency of a power amplifier (PA), when transmitting max output power P_{max,PA} with γ being the load on the PA. For example, the Physical Resource Block (PRB) utilization ratio could be used as a proxy for γ since the PR utilization ratio determines the aggregate signal power level into the PA and, therefore, a determinant of the energy dissipated by the PA to get the output signal to a desired power level.

Therefore, a seventh equation (Eqn. (7)), depicted below, (also illustrated in FIG. 17C) is derived:

$$γ = \frac{{N}_{PRB - used}}{{N}_{PRB - total}} and therefore 0 \leq γ \leq 1. \qquad Eqn . ( 7 )$$

where N_{PRB-used} is the number of allocated PBS and N_{PRB-total} is the total number of available PRBs. Further, P_{BB} denotes the power consumed by the baseband circuitry and e is a parameter that depends on the design of the PA itself.

The overall NES objective is then formalized as will now be described. An eighth equation (Eqn. (8)), depicted below (and illustrated in FIG. 18A) is used for minimizing the average network energy consumption in accordance with one or more embodiments.

$${min}_{μ} ( P ( μ ) ) = {\sum }_{n = 1}^{N} {P}_{Tr - Dep}^{n} + {P}_{fixed}^{n} . \qquad Eqn . ( 8 )$$

where μ is the policy that leads to the least power consumption through cell switch off and/or user re-association. Within the energy savings objective, the goal is to have highest carried traffic possible, therefore a ninth equation (Eqn. (9)) is derived (also illustrated in FIG. 18B).

$${max}_{λ} ( L ( {λ}_{t} ) ) = {\sum }_{n = 1}^{{N}_{serv}} {λ}_{t}^{n} . \qquad Eqn . ( 9 )$$

where Nₛₑᵣᵥ is the number of BS that are serving (e.g., 1≤Nₛₑᵣᵥ≤Nₜₒₜ) and Nₜₒₜ is the total number of cells being considered as part of the cluster for NES optimization regardless of its state (e.g., active, idle, switched off). Additionally, L(λt) denotes the aggregate traffic load and/or throughput of the network cluster being optimized at the time ‘t’.

The above formulation puts the objective in a min-max (minimum-maximum) format. Accordingly, Eqn. (8) (above and in FIG. 18A) is a minimization formulation that minimizes the average network energy consumption. Further, Eqn. (9) (above and in FIG. 18B) is a maximization formulation that maximizes the carried traffic. The minimization formulation and the maximization formulation, together, define an objective formulation.

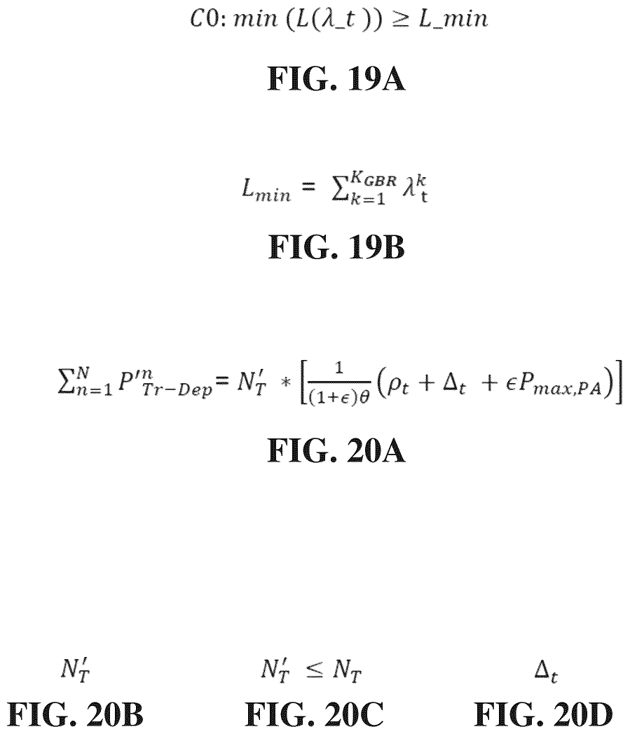

However, in order to ensure that instantaneous GBR traffic does not suffer, a further constraint, illustrated as a tenth equation (Eqn. (10)) below (also illustrated in FIG. 19A), is utilized so that EC minimization does not recommend switching off (changing to an inactive state) BSs that are critical for network GBR traffic (e.g., retain those BSs “on” or in an active state).

$$C 0 : min ( L ( λ\_t ) ) \geq L\_min . \qquad Eqn . ( 10 )$$

where an eleventh equation (Eqn. (11)) below (and depicted in FIG. 19B) applies

$${L}_{min} = {\sum }_{k = 1}^{{K}_{GBR}} {λ}_{t}^{k} . \qquad Eqn . ( 11 )$$

and K_{GBR} denotes the total number of cell sites and/or BSs that are carrying GBR traffic and p≤K_{GBR}≤N.

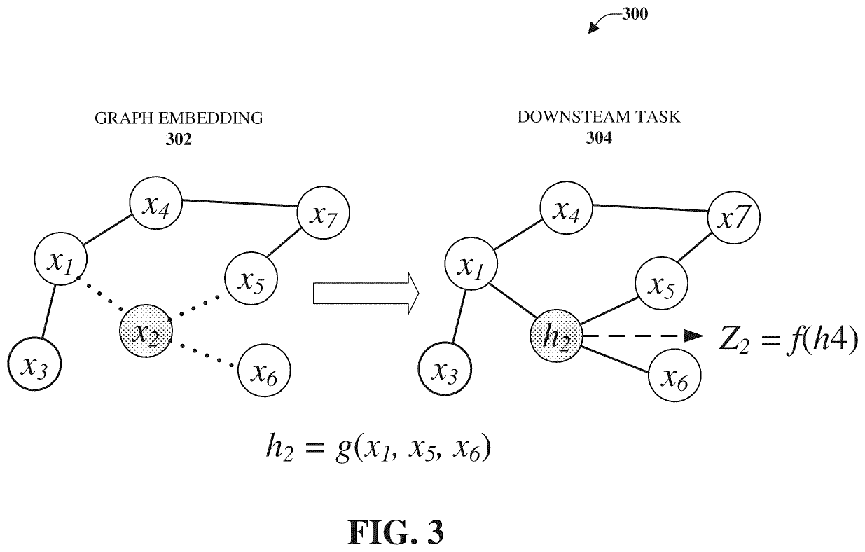

It is noted that the problem as formulated for an optimal NES state is an NP-hard problem and, therefore, does not have a deterministic polynomial time solution. Nonetheless, as a combinatorial optimization, it can potentially be solved using exhaustive search such that it iterates through every possible option in the search space (which is a high-dimensional search space). Clearly this is extremely computationally demanding, and the complexity is exponential in the number of BSs that may potentially be switched off to improve the network wide NES. Switching off any BS, adds additional costs in terms of migrating the users connected to the BS being switched off and therefore should be a consideration when determining load balancing for NES as well. The above formulation puts the objective in a min-max form and FIG. 3, discussed below, illustrates an approach to solving it using Graph Neural Networks (GNNs) in accordance with one or more embodiments.

The optimization policy relies on two sets of actions that may be recommended in order to improve the overall energy consumption of a network cluster. The actions are an EC-triggered Load Balancing and a Dynamic Cell switch ON/OFF. For the EC-triggered Load balancing, no BSs are switched off. However, a certain set of selected users are migrated to neighboring BSs to improve overall network energy consumption (NEC). According to some implementations, UE re-association is recommended in this case to Layer 3 control modules due to possibility of achieving a lower energy consumption state for the network. This action is initiated by Layer 3 only when a twelfth equation (Eqn. (12)), discussed below, shows a net benefit compared to the current state.

For the Dynamic Cell switch ON/OFF, BSs with low usage may be switched off. In the case where the BSs with low usage are switched off, all the residual users of those BSs need to be migrated in a way that the overall NES remains optimized for the remaining number of BSs that are on (e.g., in an active state), referring back to FIGS. 2A and 2B.

Note that after the re-association occurs, a new power metric needs to be computed for each of the BSs, as given by Eqn. (12) below (also illustrated in FIG. 20A)

$${\sum }_{n = 1}^{N} {P}_{Tr - Dep}^{′ N} = {N}_{T}^{′} * [ \frac{1}{( 1 + ϵ ) θ} ( {p}_{t} + {Δ}_{t} + ϵ {P}_{max , PA} ) ] . \qquad Eqn . ( 12 )$$

where

$${N}_{T}^{′}$$

(also illustrated in FIG. 20B) denotes the new MIMO mode as per EC policy (e.g., a thirteenth equation (Eqn. (13)) as per NES policy recommendation, as depicted below and also illustrated in FIG. 20C:

$${N}_{T}^{′} \leq {N}_{T} . \qquad Eqn . ( 13 )$$

With continuing reference to Eqn. (12), where Δₜ is a positive or negative number (expressed in RBs) that denotes the change in RB usage as per NES policy (also illustrated in FIG. 20D).

The aggregate power computed, per Eqn. (12) (discussed above and in FIG. 20A), should be lower than the power estimated to be consumed prior to the application of the UE association policy in order for the policy to be considered successful. It is noted that the application of NES policy may also be unsuccessful due to changing traffic condition (bursty increase) that does not allow EC to be reduced.

FIG. 3 illustrates an example, non-limiting, schematic representation of graph embedding in accordance with one or more embodiments. Provided herein is an optimal NES-based UE association utilizing graphs, according to an implementation. It is noted that, for the avoidance of doubt, any embodiments described herein in the context of optimal or optimizing any aspect are not so limited and should be considered also to cover any techniques that implement underlying aspects or parts of the described aspects to improve or increase resource allocation, one or more states, spectrum utilization, and so on, even if resulting in a sub-optimal variant obtained by relaxing aspects or parts of a given implementation or embodiment.

In an embodiment, the use of graphical networks to model and solve the problem described using neural networks internally for modeling the input-output relationships is provided herein. Accordingly, graphical neural networks can be utilized to model the wireless communication network. Illustrated on the left side of FIG. 3 is a representation of graph embedding 302 and on the right side is a graph of a downstream task 304. Nodes are represented by the circles.

Different from applications in computer vision and natural language processing (NLP), where the data is typically represented in Euclidean space, in the wireless domain, the data is better represented as a graph in a non-Euclidean space. Therefore, the techniques based on convolutional neural network (CNN), and recurrent neural network (RNN) cannot fully capture the underlying geometric structure of data in the wireless domain. GNN capture the underlying relation among the network components efficiently, which adds to its generalization capability. GNNs also fit well in the wireless domain due to their permutationally invariant operations.

Graphs are commonly expressed as G=(V, E), where V and E are the sets of nodes and edges, respectively. Let vᵢ∈V be a node in the graph and eᵢⱼ=(vᵢ,vⱼ)∈E be an edge from node vᵢ to node vⱼ, then eᵢⱼ=1 indicates that vᵢ and vⱼ are connected. If xᵢ is the feature of node vᵢ, GNN predicts the features of the node in the next layer as a function of the neighbors' features. The GNN transforms xᵢ in a latent space hᵢ that can be then used for a variety of downstream tasks on each node.

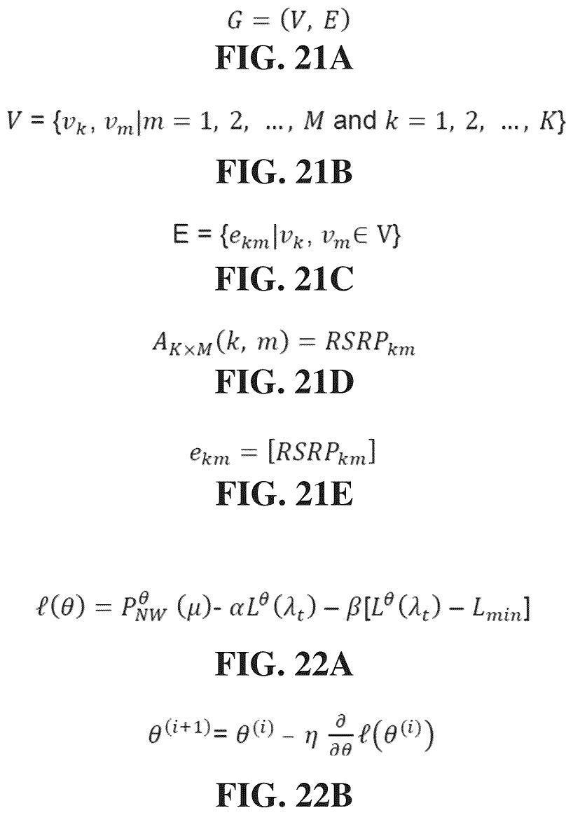

A wireless network can be represented as a graph according to the fourteenth equation (Eqn. (14)) below (also illustrated in FIG. 21A):

$$G = ( V , E ) . \qquad Eqn . ( 14 )$$

where V is defined by a fifteenth equation (Eqn. (15)), also depicted in FIG. 21):

$$V = \{ {v}_{k} , {v}_{m} \vert m = 1 , 2 , … , M and k = 1 , 2 , … , K \} . \qquad Eqn . ( 15 )$$

which denotes the set of nodes representing the UEs and radio units (RUs) in the network.

Further, E is defined by a sixteenth equation (Eqn. (16)), also depicted in FIG. 21C.

$$E = \{ {e}_{km} \vert {v}_{k} , {v}_{m} ∈ V \} . \qquad Eqn . ( 16 )$$

which denotes edges representing the link between the nodes (e.g., the UEs and RUs). The adjacency matrix of the graph is defined in the seventeenth equation (Eqn. (17)) below (also depicted in FIG. 21D):

$${A}_{K \times M} ( k , m ) = {RSRP}_{km} . \qquad Eqn . ( 17 )$$

where equation 18 (Eqn. (18)) below (also depicted in FIG. 21E) denotes the RSRP measured between node k and node m:

$$( {e}_{km} = [ {RSRP}_{km} ] . \qquad Eqn . ( 18 )$$

Alternatively, other measurements, such as signal to noise ratio (SNR) or signal to interference and noise ratio (SINR), may also be considered instead of RSRP as an edge feature. SNRs or SINRs can be obtained from one UE reporting in the case of TDD, for example.

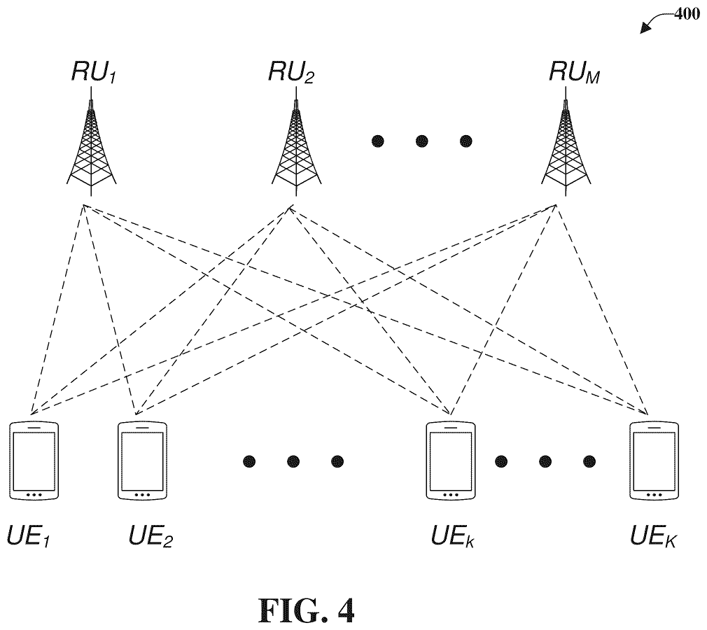

FIG. 4 illustrates a logical connectivity graph representation 400 between Cell sites (RUs) and UEs in accordance with one or more embodiments. More specifically, FIG. 4 depicts a modeling of the physical connectivity between a set of RUs that are considered as part of a cluster such that they can influence the energy consumption of one or more RUs in its neighborhood by handovers during a load balancing optimization or through migration of UEs between the cell sites. The RU features that are considered primarily as abstracted graph nodes for NES are the power consumption (Pᵢ) and relative positions of the RUs while for the UE the individual features to consider would be the traffic demand, position, mobility features such as velocity and direction of travel (away from or towards the RU) and in some cases its position being at the cell edge or not. The last aspect makes it a potential candidate for handovers during load balancing for NES for example.

The inputs to the graph based optimization for RU nodes are the current power consumption and the traffic demand on a per RU basis (by aggregating them from various UEs connected to a given RU). Note that a connectivity matrix, A is used herein and has dimensions of N×N_UE where N denotes the number of RUs that are included in the current cluster and NUE is the total number of UEs served by these N RUs. When an iteration of the optimization algorithm initiates a cell switch or user re-association operation, it is based on the recommended output of the GNN with a different connectivity matrix R′.

In the graph representation 400 of FIG. 4, the RU features are defined as [pₘ, xₘ, yₘ]. The term pₘ is the power consumption. The terms xₘ and yₘ are the respective positions of the RU. Further, the UE features are [ρₖ, vₖ, xₖ, yₖ, ηₖ]. The term ρₖ is the traffic demand and the term vₖ is the velocity of the UE. The terms xₖ and yₖ are the respective positions of the UEs. Further, the term ηₖ is the cell edge indicator {0, 1} and is set to 1 when the UE is at the cell edge.

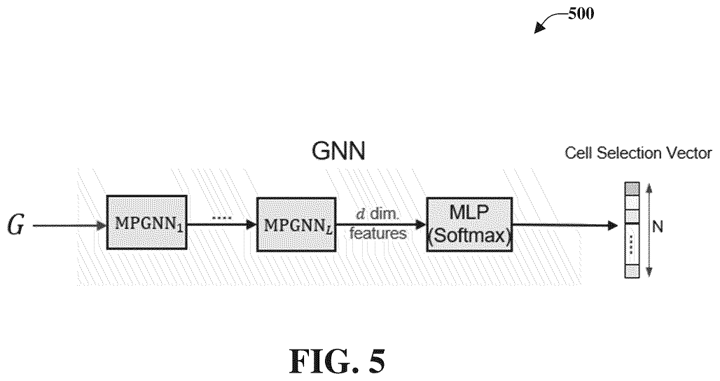

FIG. 5 illustrates an example, non-limiting, GNN 500 based representation of a network in accordance with one or more embodiments. As discussed herein, an optimal NES strategy can be obtained based on learning on GNN.

The benefit of using Neural Network (NN) architectures (e.g., CNNs and RNNs) has been the relatively low requirement on domain knowledge in order to provide results that have shown a high level of accuracy over a wide range of unknown distribution. Since these architectures are inherited from the areas of computer vision and natural language processing, such architectures are not customized to problems pertaining to wireless networks. Relatively near-optimal performance is achieved for small-scale wireless networks, but in general they fail to exploit the wireless network structure and therefore may suffer from poor scalability and generalization in large-scale network problems. Accordingly, the disclosed embodiments leverage the ability of GNN to be scalable to address the UE association problem not only at a cluster level but are also able to take a global view of the network when the UE migration results in transfer to cells outside the cluster being considered.

The GNN 500 is composed of L layers of Message Passing GNN (MPGNN) as shown in FIG. 5 (e.g., MPGNN₁ through MPGNN_{L}). After L layers of processing with MPGNN, the d dimensional features of each node, including UE nodes, are obtained. The d dimensional UE nodes feature is fed into the last MLP, followed by a softmax to obtain the N dimensional cell selection vector.

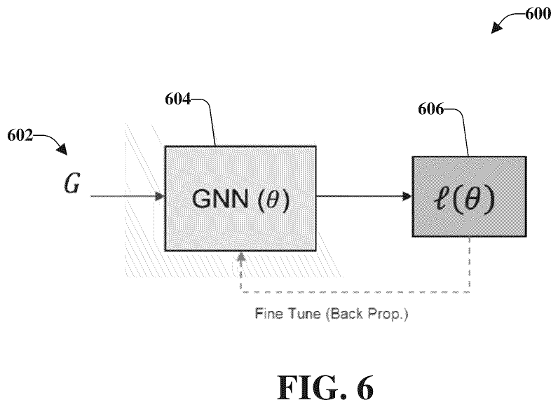

FIG. 6 illustrates an example, non-limiting, representation 600 of a GNN training process using a loss function in accordance with one or more embodiments. The loss function is represented by l(θ). For the GNN training process, θ denotes the set of parameters that is used to characterize the GNN. Then reformulate the total cluster power consumption P_{NW} and the served traffic L(λₜ) in terms of θ. Equation 19 (Eqn. (19)) below (also illustrated in FIG. 22A) defines the loss function in accordance with one or more embodiments.

$$ℓ ( θ ) = {P}_{NW}^{θ} ( μ ) - α {L}^{θ} ( {λ}_{t} ) - β [ {L}^{θ} ( {λ}_{t} ) - {L}_{min} ] . \qquad Eqn . ( 19 )$$

As depicted in FIG. 6, θ (and therefore, GNN) is obtained by using a back propagation technique by executing the following. Randomly initialize the parameter set for θ⁽⁰⁾. For each Epoch: Choose a graph G, as indicated at 602. Pass G through the GNN 604. Calculate the loss function [symbol] (θ) 606. θ is updated according to Equation 20 (Eqn. (20)) below (also illustrated in FIG. 22B).

$${θ}^{( i + 1 )} = {θ}^{( i )} - η \frac{\partial }{\partial θ} ℓ ( {θ}^{( i )} ) . \qquad Eqn . ( 20 )$$

Fine tuning (e.g., back propagation) is performed or repeated until training criteria are met. Thus, sequential, and iterative execution of the steps shown in FIG. 6 can lead to the desired learning.

In Eqn. (19), the first term minimizes P_{NW}, the second term is used to enforce to maximize the L(λₜ), and the third term is used to enforce the constraint CO that L(λₜ)≥Lₘᵢₙ. Further, the parameters α, β and η of Eqn. (19) and Eqn. (20) serve as regularization coefficients.

It is noted that in order for the GNN to be trained in a supervised manner, a large sample of labeled data set may be necessary to get a well-trained model. Typically, for wireless communications this is difficult to obtain. Therefore, according to some implementations, a combination of supervised and unsupervised training can be utilized, whereby the GNN also leverages relational learning.

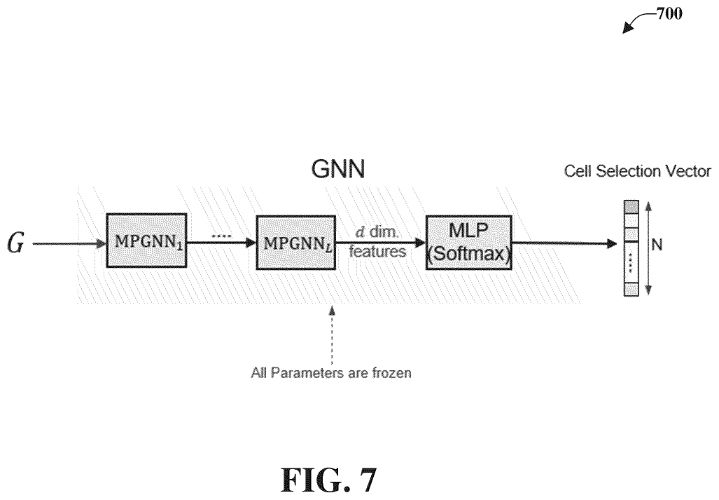

FIG. 7 illustrates an example, non-limiting, schematic representation of the deployment of the trained GNN 700 for NES in accordance with one or more embodiments. The GNN 700 is similar to the GNN 500 of FIG. 5. To deploy the GNN 700, the loss function does not need to be computed and all parameters are frozen and there is no further update as depicted in FIG. 7. According to some implementations, UE prioritization can be considered by adding some weights to specific traffic classes for those UEs.

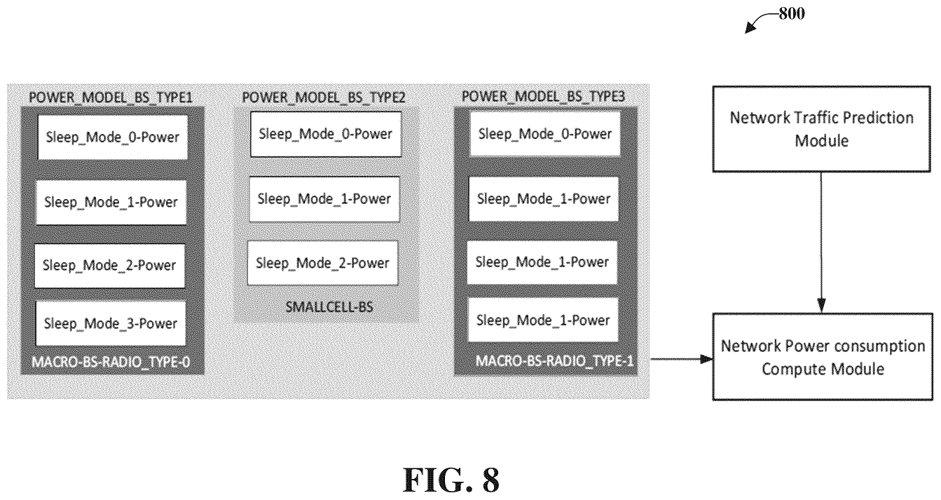

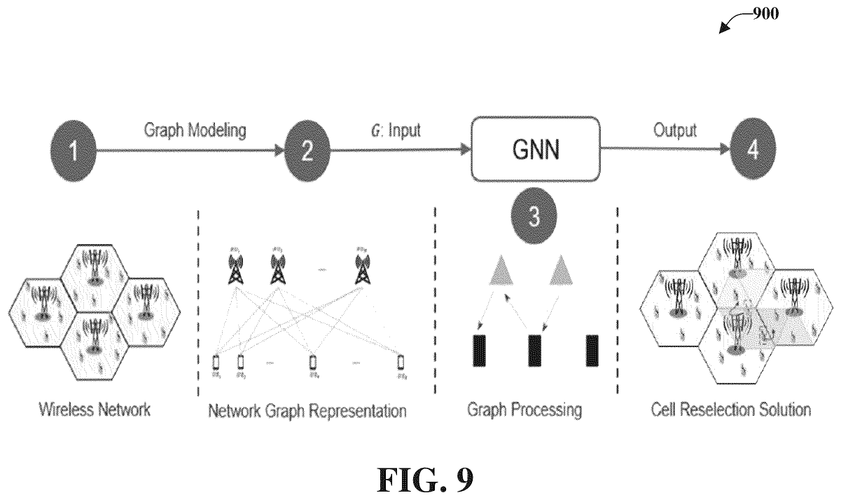

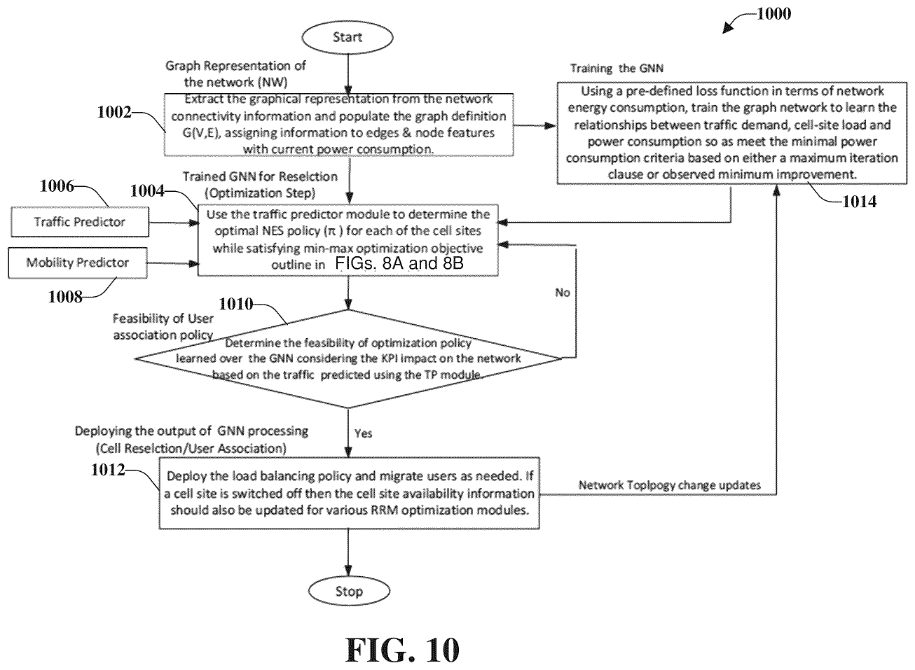

According to some implementations, provided is a pooled power consumption modeling for universal network topologies. FIG. 8 illustrates an example, non-limiting, pooled power model 800 for a heterogenous network architecture in accordance with one or more embodiments.

In various embodiments, the application of collaborative learning for diverse RF environments and devices is provided, which can enhance the performance of a number of RF frontends and/or devices simultaneously (at substantially a same time, at a similar time, etc.). When a network energy savings minimization functionality is applied across multiple cell sites within a cluster or across multiple adjacent clusters, it is possible that the optimization should be carried out over cell sites with different capabilities. One topology is that of an overlay-underlay network with macro cells providing all the control functionality with some data connectivity and the bulk of the data traffic is supported through lower power small cells. NES in such a network is relatively easy to obtain.

According to some implementations, automatic scalability to change in environment or action space is provided. GNNs can easily augment or accommodate changes in network topology by adding additional edges or changing the connectivity structure of the graph to reflect the changes that the network undergoes through its lifetime. Fundamentally, since GNNs rely on relational learning, the dynamic interaction for the new or augmented network topology (for example as more BSs are added for densification or coverage) can be made transparent to the user while these updates are made due to the permutation invariance property of the underlying GNNs.

The following provides an example of how the proposed embodiments may be applied to the problem of user association in a wireless network carrying live traffic in order to optimize the energy efficiency. The load rebalancing for better NES (e.g., improved NES as compared to a current NES) can be initiated either through a periodic trigger or through monitoring EC levels and initiated through an EC level reaching a relatively higher range (as determined by MNO policy for example). In this regard, FIG. 9 illustrates an example, non-limiting, process flow of the use of GNN for energy efficient user (e.g., UE) association in accordance with one or more embodiments. More specifically, FIG. 9 illustrates an entire process of transforming from a given network topology, to its graphical representation, to using such graph rendering to arrive at an optimal user association policy that prioritizes NES in accordance with one or more embodiments.

Stage 1 in FIG. 19 depicts cells in a wireless network as previously mentioned (e.g., in FIG. 1) and one configuration is to consider a tri-sector division of each of the cell such that each cell site covers 120 degrees. The graph based cell reselection and load balancing for NES can proceed using the following high level steps. First, the wireless network is defined using its topology and all related configurations. The network is converted to its graphical representation (e.g., G), and the edges and nodes' features are defined. The graphical representation (G) is passed to an already-trained GNN for processing over the input graph. Further, the cell reselection solution is received as a connectivity matrix at the output of GNN representing the connection of each UE to a unique RU.

FIG. 10 illustrates an example, non-limiting, flow diagram of an example, non-limiting, computer-implemented method 1000 that facilitates cell reselection in accordance with one or more embodiments described herein. The computer-implemented method 1000 and/or other methods discussed herein can be implemented by network equipment comprising a processor. According to another example, the computer-implemented method can be implemented by a system comprising a processor and a memory.

In further detail, the computer-implemented method begins with input data, which can include a graph representation of the network (NW). At 1002, the graphical representation can be extracted from the network connectivity information. Further, at 1002, the graph definition G(V,E) can be populated and information can be assigned to edges and node features with the current power consumption.

Based on a trained GNN for reselection (e.g., an optimization step), the computer-implemented method 1000 continues at 1004 based on input data that includes the output of 1002 and indicative of traffic predictor information 1006 and mobility predictor information 1008. Thus, at 1004, the traffic predictor module is utilized to determine the optimal NEW policy (π) for each of the cell sites while satisfying min-max (minimum-maximum) optimization objective as discussed with respect to FIG. 18A (minimized) and FIG. 18B (maximized).

The computer-implemented method 1000 continues, at 1010 and a determination is made whether the feasibility of the optimization policy learned over the GNN is determined. The determination at 1010 can include considering the Key Performance Indicator (KPI) impact on the network based on the traffic predicted using the TP module.

If it is determined that UE association policy is not feasible (“NO”), the computer implemented method returns to 1004 for subsequent processing. Alternatively, if it is determined that UE association policy is feasible (“YES”), at 1012, the load balancing policy is deployed and UEs are migrated, as needed. If a cell site is switched off, then the cell site availability information should also be updated for various Radio Resource Management (RRM) optimization modules.

Information from the processing at 1002 can be utilized as input to train the GNN at 1014. Alternatively or additionally, information indicative of the network topology change updated can be utilized as input to train a GNN at 1014. Training the GNN can include using a pre-defined loss function in terms of network energy consumption. The graph network can be trained to learn the relationships between traffic demand, cell-site load, and power consumption. In such a manner, the GNN model can be trained to meet (e.g., satisfy) the minimal power consumption criteria based on either a maximum iteration clause or an observed minimum improvement.

The GNN model can be trained to a defined level of confidence. The defined level of confidence can be a percentage of an accuracy level (e.g., 80% accuracy, 90% accuracy, and so on) that is determined to be sufficient to achieve advantages of as discussed herein. According to some implementations, feedback data, after network topology changes can be utilized to determine the accuracy level of the model.

In FIG. 10, the steps to be taken in order to use the methods disclosed herein in order to address optimal user association for NES minimization while maximizing total network throughput are provided. It is noted that the training at 1014 is carried out only periodically after the first initialization to make sure that the trained network is current. Any non-transitory changes to the topology also trigger a re-training of the GNN. If the optimization iteration produces a non-feasible result then this feedback is provided to the GNN optimization step and added as a further constraint for future optimization iterations.

As discussed herein provided are embodiments related to performing user (UE) association that minimizes network energy consumption while meeting a network average throughput requirement. According to an embodiment, the network can be transformed into a graphical representation to derive the optimal policy for network energy minimization. Based on the graphical representation of the network, message passing GNN (MP-GNN) can be used to train the graphical network to achieve a network energy savings minimization while maximizing the traffic carried out under such ES constraint.

According to some embodiments, nodes can be added and removed as the network grows allowing for scalability while minimizing network energy consumption while achieving a network average throughput requirement for both greenfield and existing networks. In some embodiments, GNNs other than message passing (MP-GNNs) may also be used. Further, according to various embodiments, any weighted combination of the QoS requirements may serve as a constraint.

As discussed, user association plays a critical role in interference management, load balancing, energy consumption and spectral efficiency for wireless communication networks as it determines the effective load on each serving base station (BS). While traditional methods have relied mostly on signal strength based metrics such as received signal reference power (RSRP) and the like to determine the cell site that a given user should associate with, increasing burdens of base stations due to high traffic demand can potentially create hotspots and over-burden some base stations with relatively greater traffic demand and consequently increased power consumption. This can occur when certain neighboring BSs are carrying relatively lower traffic and, therefore, in order to improve fairness of use, network operators may need to balance out the load in the network across the deployed BSs. While traffic load balancing has been considered in the past and some deterministic optimization based techniques have been proposed, a load balancing approach based on network energy savings (NES) was not considered, and is provided herein. Moreover, the optimization techniques considered previously scale poorly as the network size increases as the computational load becomes formidable with more BSs in network clusters. Therefore, provided herein are embodiments that address the issue of balancing energy consumption and improve overall NES in a scalable manner using data-driven approaches that can apply appropriate energy savings actions to the network clusters that need the most attention.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Example, non-limiting Non-Real Time RAN Intelligent Controller (Non-RT RIC) functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU and O-DU nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) is designed to handle network functions at real time timescales (e.g., a third range of time representing less time than the first time range and the second time range, such as <10 milliseconds).

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

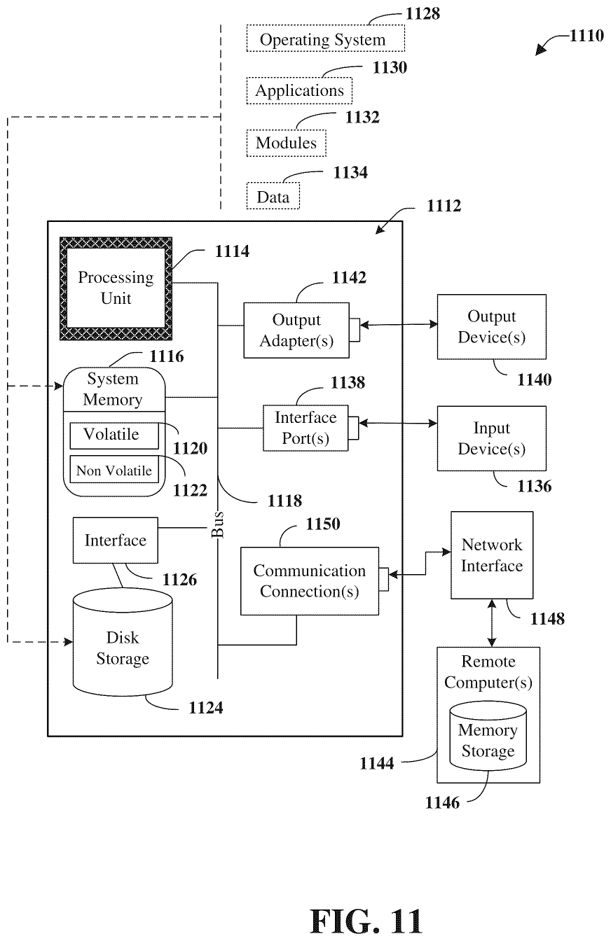

In order to provide a context for the various aspects of the disclosed subject matter, FIG. 11 as well as the following discussion are intended to provide a brief, general description of a suitable environment in which the various aspects of the disclosed subject matter can be implemented.

With reference to FIG. 11, an example environment 1110 for implementing various aspects of the aforementioned subject matter comprises a computer 1112. The computer 1112 comprises a processing unit 1114, a system memory 1116, and a system bus 1118. The system bus 1118 couples system components including, but not limited to, the system memory 1116 to the processing unit 1114. The processing unit 1114 can be any of various available processors. Multi-core microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 comprises volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can comprise read only memory (ROM), programmable ROM (PROM), electrically programmable ROM (EPROM), electrically erasable PROM (EEPROM), or flash memory. Volatile memory 1120 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also comprises removable/non-removable, volatile/non-volatile computer storage media. FIG. 11 illustrates, for example a disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software comprises an operating system 1128. Operating system 1128, which can be stored on disk storage 1124, acts to control and allocate resources of the computer 1112. System applications 1130 take advantage of the management of resources by operating system 1128 through program modules 1132 and program data 1134 stored either in system memory 1116 or on disk storage 1124. It is to be appreciated that one or more embodiments of the subject disclosure can be implemented with various operating systems or combinations of operating systems.

A user enters commands or information into the computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 comprise, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapters 1142 are provided to illustrate that there are some output devices 1140 like monitors, speakers, and printers, among other output devices 1140, which require special adapters. The output adapters 1142 comprise, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically comprises many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the system bus 1118. While communication connection 1150 is shown for illustrative clarity inside computer 1112, it can also be external to computer 1112. The hardware/software necessary for connection to the network interface 1148 comprises, for exemplary purposes only, internal and external technologies such as, modems including regular telephone grade modems, cable modems and DSL modems, ISDN adapters, and Ethernet cards.

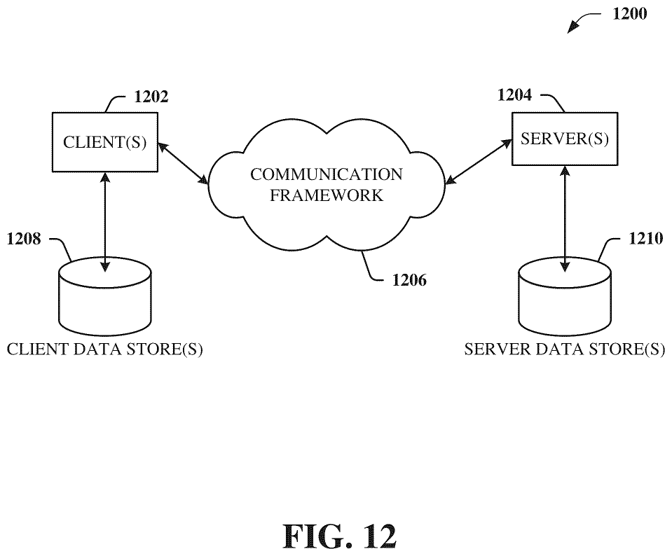

FIG. 12 is a schematic block diagram of a sample computing environment 1200 with which the disclosed subject matter can interact. The sample computing environment 1200 includes one or more client(s) 1202. The client(s) 1202 can be hardware and/or software (e.g., threads, processes, computing devices). The sample computing environment 1200 also includes one or more server(s) 1204. The server(s) 1204 can also be hardware and/or software (e.g., threads, processes, computing devices). The servers 1204 can house threads to perform transformations by employing one or more embodiments as described herein, for example. One possible communication between a client 1202 and servers 1204 can be in the form of a data packet adapted to be transmitted between two or more computer processes. The sample computing environment 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGS., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising at least one processor, respective results of application of an objective formulation to respective combinations of a specified user equipment of a source cell and respective target cells of a group of target cells, wherein a communication network comprises the source cell and the group of target cells; and
based on the respective results of the application of the objective formulation, facilitating, by the system, user equipment association that defines an action for a network traffic load balancing process that transfers network traffic of the specified user equipment from the source cell to a target cell of the group of target cells.

2. The method of claim 1, wherein the determining of the respective results of application of the objective formulation comprises:
based on the user equipment association, determining a first result of a minimization formulation that minimizes an average energy consumption of the communication network, as compared to a currently measured average energy consumption; and
determining a second result of a maximization formulation that maximizes a carried traffic metric of the communication network, as compared to a currently measured carried traffic metric during the facilitating the user equipment association.

3. The method of claim 2, wherein the determining of the first result comprises:
applying a constraint to the minimization formulation, wherein the constraint facilitates maintaining cells, determined to be necessary for network guaranteed bit rate traffic, in an active state.

4. The method of claim 3, wherein the applying of the constraint comprises maintaining a defined guaranteed bit rate level for instantaneous minimization formulation bit rate traffic.

5. The method of claim 1, further comprising:
prior to the determining of the respective results of the application of the objective formulation, transforming, by the system, details of the communication network into a graphical representation; and
based on the graphical representation and based on real-time conditions, generating, by the system, a policy, wherein the policy facilitates a reduction in an amount of energy consumed by the communication network, as compared to a current energy consumption level.

6. The method of claim 5, further comprising:
prior to the generating of the policy and based on the graphical representation, training, by the system, a model to a defined confidence level.

7. The method of claim 6, wherein the model is a graph neural network model.

8. The method of claim 7, wherein the graph neural network model is a message passing graph neural network model.

9. The method of claim 1, further comprising:
prior to the determining of the respective results of application of the objective formulation and based on a traffic class of the specified user equipment, applying, by the system, a weighted value in the objective formulation for the specified user equipment, wherein the weighted value defines a prioritization assigned to the specified user equipment.

10. The method of claim 9, wherein a weighted combination of quality of service parameters serves as a constraint within the objective formulation.

11. The method of claim 1, wherein the source cell and the group of target cells are configured to operate according to a fifth generation radio network communication protocol.

12. A system, comprising:
a processor; and
a memory that stores executable instructions that, when executed by the processor, facilitate performance of operations, comprising:
performing a network traffic load balancing procedure that moves network traffic of a user equipment from a source cell to a specified target cell within a communication network, wherein the performing comprises:
determining respective results of application of an objective formulation to respective combinations of the user equipment and respective target cells of a group of target cells of the communication network; and
based on the respective results and a determination that the specified target cell satisfies an energy consumption condition, transferring the network traffic of the user equipment from the source cell to the specified target cell.

13. The system of claim 12, wherein the operations further comprise:
prior to the determining of the respective results of the application of the objective formulation, training a first model to a defined confidence level.

14. The system of claim 13, wherein the first model is a graph neural network model.

15. The system of claim 12, wherein the objective formulation facilitates a tradeoff between user equipment quality of service and an energy consumption of the communication network.

16. The system of claim 15, wherein the user equipment quality of service is defined for respective user equipment classes of user equipment within the communication network.

17. The system of claim 12, wherein the operations further comprise:
determining network guaranteed bit rate traffic is dependent on the source cell being in an active state; and
preventing a change in state of the source cell from the active state to an inactive state, wherein the preventing comprises applying a constraint to the objective formulation.

18. A non-transitory machine-readable medium, comprising executable instructions that, when executed by a processor of network equipment, facilitate performance of operations, wherein the operations comprise:
determining respective results of application of an objective formulation to respective combinations of a user equipment connected to a communication network via a source cell and respective target cells of a group of target cells, wherein the communication network comprises the source cell and the group of target cells; and
based on the respective results of the application of the objective formulation, implementing a network traffic load balancing process that transfers the defined user equipment from being connected to the source cell to being connected to a target cell selected from the group of target cells.

19. The non-transitory machine-readable medium of claim 18, wherein the operations further comprise:
based on a graphical representation of the communication network, using a model trained to a defined level of confidence, wherein the model is a graph neural network model.

20. The non-transitory machine-readable medium of claim 18, wherein the objective formulation is based on an optimization function that facilitates a tradeoff between network energy savings and maintaining a user equipment quality of service at a defined level, and wherein the user equipment quality of service is defined for respective user equipment classes of user equipment within the communication network.
